(19) United States
(12) Patent Application Publication
(10) Pub. No.: US 2014/0012869 A1
(43) Pub. Date: Jan. 9, 2014

(54) BUSINESS OBJECT BROWSER

(71) Applicant: Jan HRASTNIK, Sandhausen (DE)

(72) Inventor: Jan HRASTNIK, Sandhausen (DE)

(73) Assignee: SAP AG, Walldorf (DE)

(21) Appl. No.: 13/542,417

(22) Filed: Jul. 5, 2012

(51) Int. Cl. G06F 17/30

(52) U.S. Cl. 707/769; 707/E17.014

(57) ABSTRACT

A search area to search business object instance(s), business object(s), node(s), and/or data types may be displayed. Business object instance(s), business object(s), node(s), and/or data type(s) based on search criteria specified in the search area may be displayed. In response to identification of a business object instance, a business object, a node, or a data type, information pertaining to the identified business object instance, business object, node, or data type may be displayed.

### BACKGROUND

Business software such as enterprise resource planning (ERP) software implements business processes by modeling business data as business objects (BOs) with data exchange between the BOs. The business data provided via BOs can be accessed through mechanisms such as user interfaces, forms, and analytical reports.

Traditionally, it has been difficult for a third party (such as a partner or a consumer) to customize software since the third party did not have an intuitive view of BOs and related software building blocks such as BO instances, nodes, data types, attributes, etc. Therefore customization of software has been a process which does not scale easily.

### BRIEF DESCRIPTION OF THE DRAWINGS

FIG. 1 illustrates a graphical user interface (GUI) to search for BO instances, BOs, and/or nodes.

FIG. 2 illustrates a GUI to display BOs, BO instances, and/or nodes and associated attributes according to an embodiment.

FIG. 3 illustrates a GUI to display associated BOs, BO instances, and/or nodes of an identified BO, BO instance, and/or node according to an embodiment.

FIG. 4 illustrates a GUI to search and display details of BOs according to an embodiment.

FIG. 5 illustrates a GUI to search and display details of attributes according to an embodiment.

FIG. 6 illustrates a GUI to search and display details of data types according to an embodiment.

FIG. 7 illustrates a GUI to search and display details of BOs, BO instances, and/or nodes as a tree representation according to an embodiment.

FIG. 8 shows an exemplary architecture in an embodiment.

### DETAILED DESCRIPTION

Embodiments may be discussed in systems to efficiently display information related to BO instances, BOs, and/or nodes. In an embodiment, a search area to search business object instance(s), business object(s), node(s), and/or data types may be displayed. Business object instance(s), business object(s), node(s), and/or data type(s) based on search criteria specified in the search area may be displayed. In response to identification of a business object instance, a business object, a node, or a data type, information pertaining to the identified business object instance, business object, node, or data type may be displayed.

In an embodiment, the displayed information may be corresponding attribute names, attribute user interface texts, and attribute values of attributes belonging to the identified business object, business object instance, or node. In an embodiment, the displayed information may be associated business object instances, associated business objects, and/or associated nodes associated with the identified business object, business object instance, or node. In an embodiment, the displayed information may be release status, write access, and/or mandatory indicator of the identified business object, business object instance, or node. In an embodiment, the displayed information may be available data type values and corresponding data type value descriptions of the identified data type. In an embodiment, the displayed information may be a tree representation of the identified business object, business object instance, or node.

Business software usually includes a standard set of BOs which can be utilized by the software user to model a business organization and the activities pertaining to the business organization. For example, in an embodiment, business software may include BOs representing sales orders, sales quotes, customer quotes, service documents, business opportunities, production models, and production segments. There may be multiple instances of a BO. For example, a business organization may receive multiple sales orders, and each sales order may be represented by a sales order BO instance.

In an embodiment, a BO and/or BO instance may contain a set of nodes. Each node of a BO instance may represent information about the BO instance. For example, a sales order received by a business organization may be represented by a sales order BO instance. The sales order BO instance may include nodes representing a product within that sales order, a delivery location of the sales order, etc. In an embodiment, a root node of the BO instance may represent the BO instance. In an embodiment, one or more nodes in a BO instance may themselves be BO instances. For example, a product BO instance may be a node included within a sales order BO instance.

In an embodiment, a BO, BO instance, and/or nodes may contain a set of attributes.

Each attribute may represent information about the BO instance and/or node. For example, a sales order received by a business organization may be represented by a sales order BO instance. The sales order BO instance may include attributes representing, for example, the price of the sales order, the time of delivery of the sales order, etc.

In an embodiment, a node from a BO and/or BO instance may be associated with a node from another BO and/or BO instance. For example, a sales quote BO instance may represent a sales quote given by a seller to a consumer. The consumer may then place a sales order based on the sales quote. Therefore, the product in the sales quote and the product in the sales order may be the same. To represent the relationship between the sales order and the sales quote, the product node in the sales quote BO instance may be associated with the product node in the sales order BO instance. In an embodiment, since the sales order is fulfilled based on the initial sales quote, the root node of the sales quote BO instance may be associated with the root node of the sales order BO instance. In an embodiment, a node from a BO instance may be associated with another node in the same BO instance.

In an embodiment, a software provider may provide the software to a third party, called a software partner, and the software partner may customize the software further and provide the software to the ultimate software consumer. The software partner may customize the software to fit particular needs of a type of consumer.

For example, in an embodiment, a business software consumer such as an automobile seller may be interested in purchasing business software to model the consumer's business. A software provider may provide business software with generic BOs to a partner specializing in the automobile industry. The business software with generic BOs may include a generic sales quote BO. The generic sales quote BO may include a field to specify a type of product such as a car. However, the generic sales quote BO may not allow for enough granularity to specify the exact make and model of the car. Therefore the software provider may provide the partner with tools to extend the generic sales quote BO. Since the partner specializes in the automobile industry, the partner may extend the generic sales quote BO such that the exact make and model of the car can be specified. The partner may then provide the software to the business software consumer (the automobile seller) with the added functionality. In an embodiment, the software provider may directly provide the business software consumer with tools to extend the generic sales quote BO. Thus, instead of the partner, the business software consumer may extend the generic sales quote BO such that the exact make and model of the car can be specified.

Traditionally, it has been difficult for a third party (such as a partner or a consumer) to customize software since the third party did not have an intuitive view of BOs and related software building blocks such as BO instances, nodes, data types, attributes, etc. Therefore customization of software has been a process which does not scale easily.

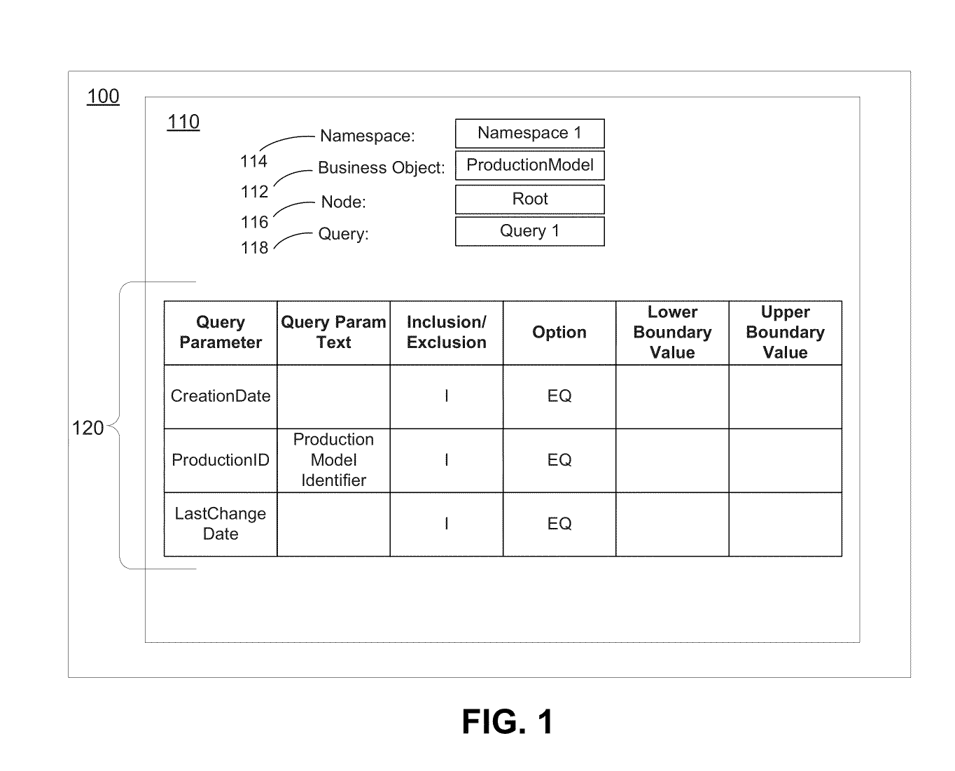

FIG. 1 illustrates a GUI 100 to search for BOs, BO instances, and/or nodes according to an embodiment. The GUI 100 may include an area 110 to specify search parameters. In an embodiment, the search area 110 may include parameter fields such as a namespace field 114, a BO field 112, a node field 116, and/or a query field 118. In an embodiment, the search area 110 may include parameter fields to specify query parameters 120. In an embodiment, the query parameters 120 may be the query parameters associated with the query specified in the query field 118. Based on the values specified in the parameter fields, BOs, BO instances, and/or nodes matching the parameter values may be displayed in GUI 100 or in another GUI.

For example, in an embodiment, a user may specify the values: “production model,” in the BO field 112, “root” in the node field 116, and “query 1” in the query field 118. The GUI 100 may automatically populate the relevant query parameters associated with query 1 in the area to specify query parameters 120. The user may then modify the values of the query parameters 120 such as “creation date,” “productionID,” and “last change date.” As a result, the root nodes of production model BO instances with attribute values matching the query parameters 120 may be displayed in GUI 100 or another GUI. In an embodiment, the query parameters field 120 may contain an option to exclude BOs, BO instances, and/or nodes based on the attribute values of certain attributes. In an embodiment, instead of specifying the exact value of a query parameter, a range may be specified with a lower boundary value and an upper boundary value.

In an embodiment, the available values for the search fields displayed in search area 110 may be shown via a pre-populated drop down menu. In an embodiment, the values for the search fields may be typed in manually as a text string.

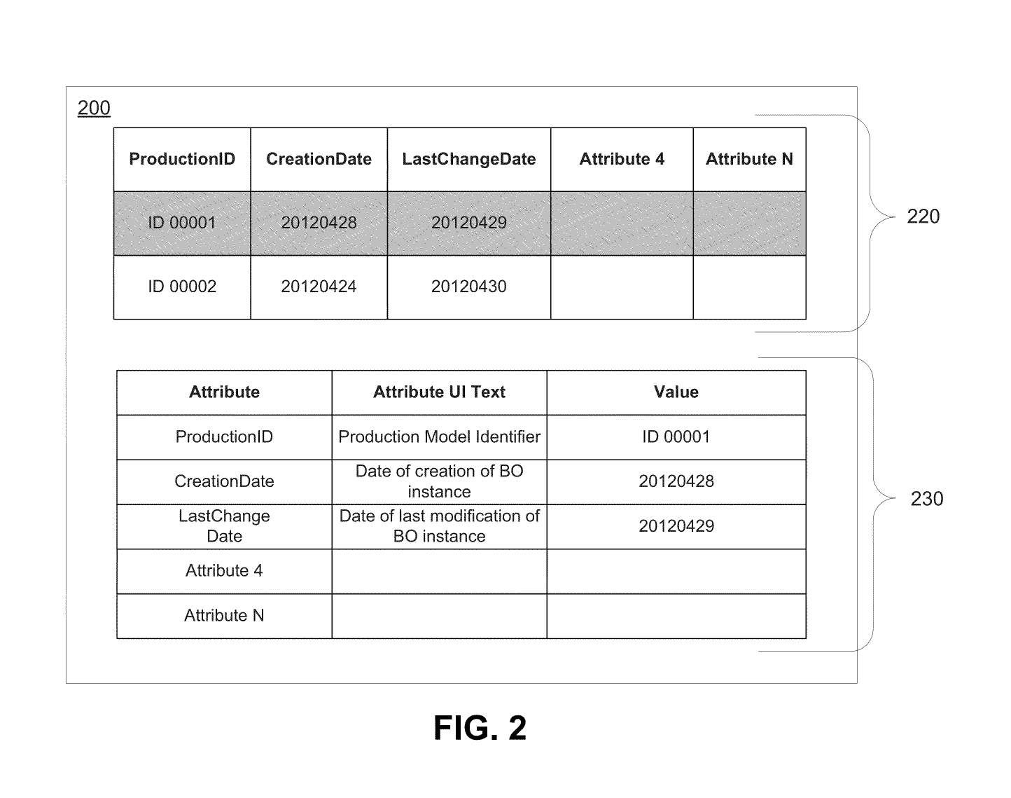

FIG. 2 illustrates a GUI 200 to display BOs, BO instances, and/or nodes and the associated attributes according to an embodiment. In an embodiment, in response to an indication to search for BOs, BO instances, and/or nodes, a GUI such as the GUI 200 may be displayed. The GUI 200 may display all BOs, BO instances, and/or nodes matching the search criteria in a first display area 220. BOs, BO instances, and/or nodes displayed in the first display area 220 may be selected by, for example, clicking on the BO(s), BO instance(s), and/or node(s). The GUI 200 may display the attributes of the selected BO(s), BO instance(s), and/or node(s) in a second display area 230.

In an embodiment, the first display area 220 may display attribute(s) of the displayed BOs, BO instances, and/or nodes. The first area 220 may display the attributes(s) of the BOs, BO instances, and/or nodes and the may present the information in an organized manner. For example, in an embodiment, the first area 220 may display the BOs, BO instances, and/or nodes in a table format. Each row of the table may represent a BO, BO instance, or node, and each column of each row may present attribute(s) of that BO, BO instance, or node.

In an embodiment, the second display area 230 may display attribute(s) of a selected BO(s), BO instance(s), and/or node(s). In an embodiment, a displayed BO, BO instance, or node may be selected by clicking on the row representing the BO, BO instance, or node in the first display area 220. In response to selecting a BO, BO instance, or node in the first area 220, the row representing the BO, BO instance, or node may be highlighted, outlined by a shadow, etc., to indicate that the BO, BO instance, or node has been selected. In an embodiment, in response to selecting a BO, BO instance, or node in the first area 220, attribute(s) of that BO, BO instance, or node may be automatically populated in the second area 230.

The second area 230 may display a technical identifier of the attribute(s), a user-friendly identifier of the attribute(s), known as attribute user interface (UI) text, and/or the value(s) of the attribute(s). The technical identifier of an attribute may be an identifier used during programming of software to identify an attribute. The user-friendly identifier of an attribute may be a more descriptive identifier which relays more information about the attribute to a user. For example, a production model BO instance may include an attribute identifying the creation date of the production model BO instance. The creation date attribute may be identified by a terse technical identifier such as “creationDate,” but may be identified by a more descriptive user-friendly identifier such as “date of creation of BO instance.”

Similarly, in an embodiment, the attribute values displayed on the GUI 200 may be shown in a technical format and/or in a user-friendly format. The technical attribute value may be used during programming of software to identify the attribute value. The user-friendly attribute value may be a more descriptive value which relays more information to a user. For example, a production model BO instance may include an attribute value identifying the creation date of the production model BO instance. The creation date attribute value may be presented as a terse technical value such as “20120428,” but may also be presented as a more descriptive user-friendly value such as “Apr. 28, 2012.”

In an embodiment, the GUI 200 may display mechanisms to view BO, BO instance, or node information unable to fit on the GUI 200. For example, in an embodiment, the number of BOs, BO instances, and/or nodes corresponding to a search criteria and/or the attributes of the BOs, BO instances, and/or nodes may exceed the number of BOs, BO instances, and/or nodes and/or the number of attributes displayable on the GUI 200. In an embodiment, the GUI 200, the first area 220, and/or the second area 230 may include buttons (not shown) to scroll horizontally and/or the vertically across the results from the search criteria. For example, in an embodiment, the first area 220 may only be capable of displaying 50 attributes. However, each BO, BO instance, or node may include 100 attributes. Thus, initially, only the first 50 attributes of each BO, BO instance, or node may be displayed on the first area 220, and a button labeled “next attributes” may be presented on the GUI 200. Clicking on the button may display the second 50 attributes (i.e., attributes 50 to 100).

A person having ordinary skill in the art will appreciate that the scrolling mechanism can be implemented in various ways including horizontal and vertical scroll bars, clickable arrows, dragging/swiping with the mouse pointer, etc.

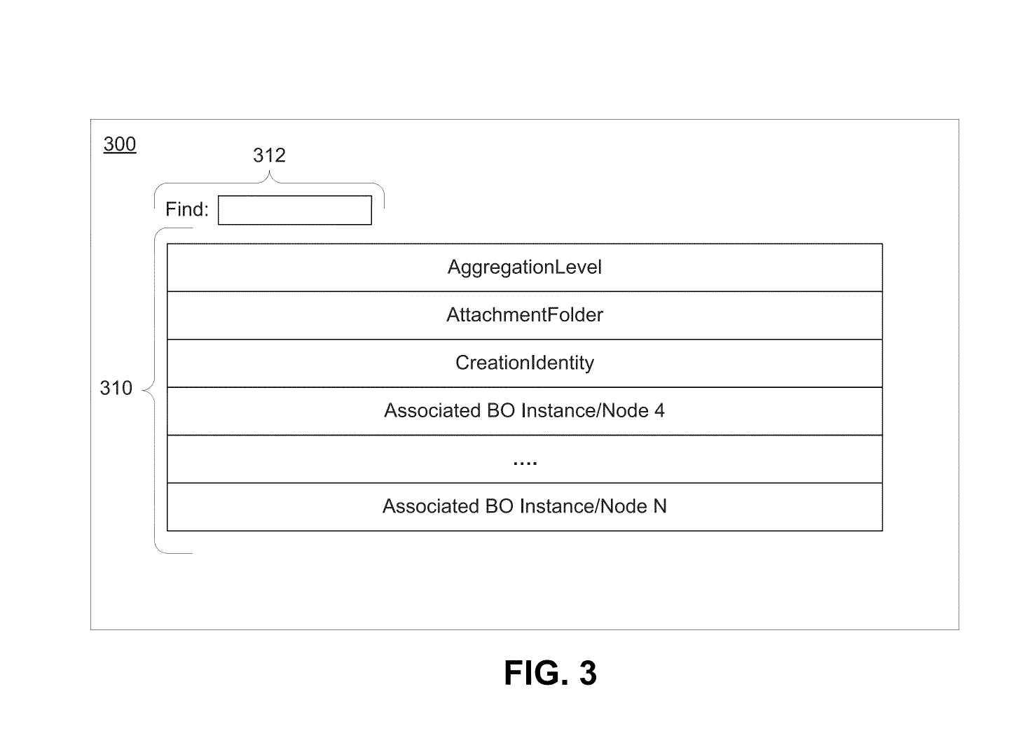

FIG. 3 illustrates a GUI 300 to display associated BOs, BO instances, and/or nodes of an identified BO, BO instance, or node according to an embodiment. In an embodiment, after identifying a BO, BO instance, or node (for example, by utilizing a GUI such as the one discussed in FIG. 2), the user may be presented with a GUI 300. GUI 300 may display the associated BOs, BO instances, and/or nodes of the identified BO, BO instance, or node in an organized manner. For example, in an embodiment, the GUI 300 may display the associated BOs, BO instances, and/or nodes 310 in a table format. Each row of the table may represent a BO, BO instance, or node.

In an embodiment, selecting an associated BO, BO instance, or node in GUI 300 may display the attributes, attribute UI text, and attribute values as discussed with reference to GUI 200 (FIG. 2) above. In an embodiment, the GUI 300 may display mechanisms to view BO, BO instance, or node information unable to fit on the GUI 300 as discussed with reference to GUI 200 (FIG. 2) above.

In an embodiment, a filtering field 312 may be displayed on GUI 300. The user may type in an identifier or a portion of an identifier identifying any of the associated BOs, BO instances, and/or nodes 310, and in response, only the associated BOs, BO instances, and/or nodes matching the typed in identifier or portion of the identifier may be displayed. For example, in an embodiment, typing in the phrase “Agg,” may filter the displayed BOs, BO instances, and/or nodes such that only the BO, BO instance, or node, “AggregationLevel” may be displayed since the identifiers of other BOs, BO instances, and/or nodes may not include the phrase “Agg.”

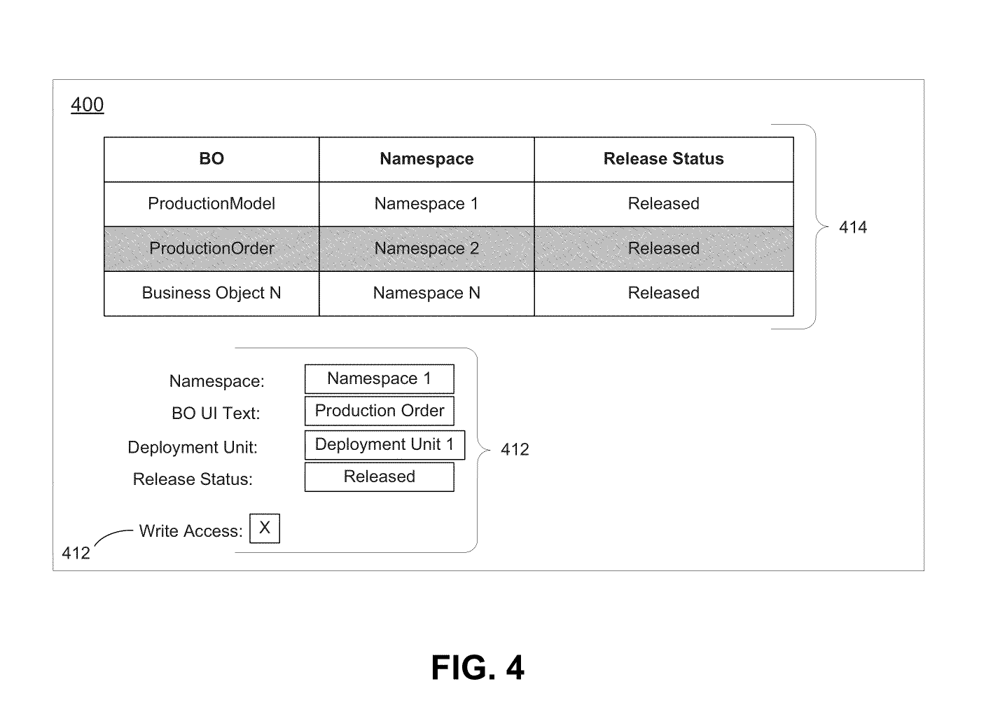

FIG. 4 illustrates a GUI 400 to search and display details of BOs according to an embodiment. In an embodiment, the GUI 400 may include a search area (not shown) similar to the search area described in GUI 100 (FIG. 1). In an embodiment, in response to a search, the GUI 400 may display BOs 414 matching the search criteria. In an embodiment, the BOs may be displayed with information related to the BOs in an organized manner. For example, in an embodiment, the GUI may display the BOs in a table format. Each row of the table may represent a BO, and each column of each row may present information related to that BO.

In an embodiment, detailed information 412 related to a selected BO may be presented. In an embodiment, a displayed BO may be selected by clicking on the row representing the BO. In response to selecting a BO, the row representing the BO may be highlighted, outlined by a shadow, etc., to indicate that the BO has been selected. In an embodiment, in response to selecting a BO, information 412 related to that BO instance may be automatically populated and displayed.

In an embodiment, the information related to BO(s) displayed may include an identifier identifying each BO, a namespace, the release status of the BO, the BO UI text (i.e., the user-friendly description of the BO), and whether there is write access to the BO. In an embodiment, the write access information may be displayed for different types of users. For example, in an embodiment, the write access level for a partner may be displayed. In another embodiment, the write access level for a consumer of the software may be displayed.

In an embodiment, the GUI 400 may display mechanisms to view BO information unable to fit on the GUI 400 as discussed with reference to GUI 200 (FIG. 2) above. In an embodiment, a filtering field (not shown) may be displayed on GUI 400, and may operate as discussed with reference to GUI 300 above.

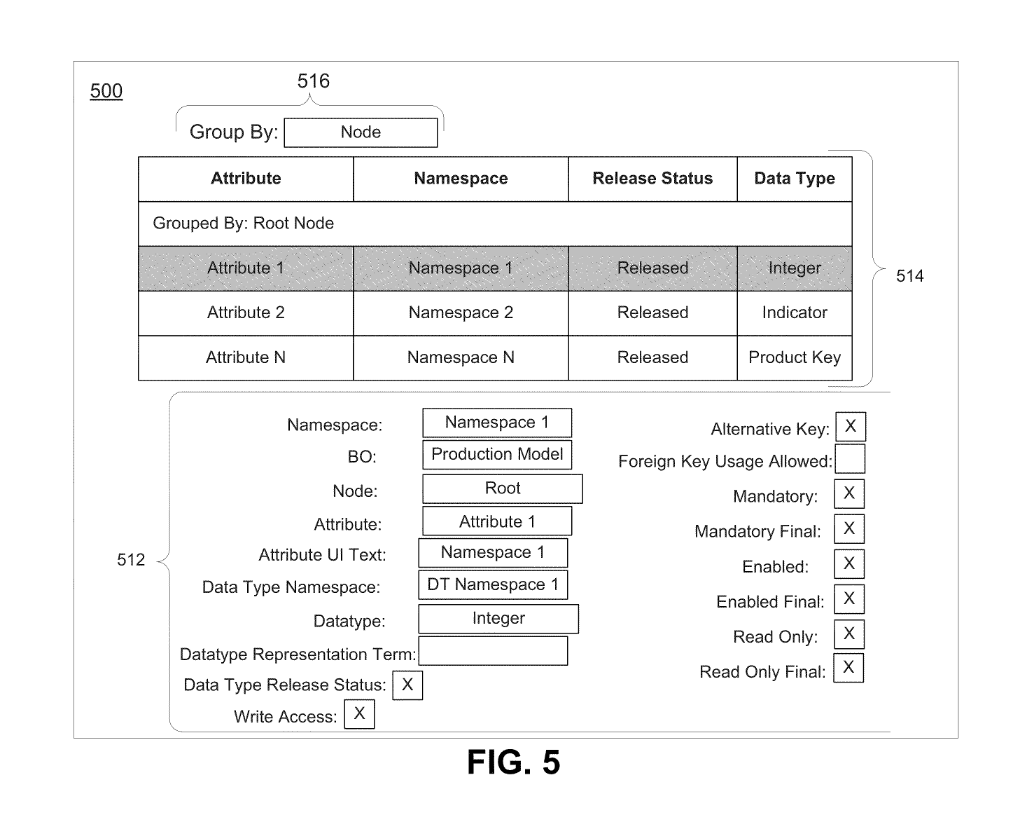

FIG. 5 illustrates a GUI 500 to search and display details of attributes according to an embodiment. In an embodiment, the GUI 500 may include a search area (not shown) similar to the search area described in GUI 100 (FIG. 1). In an embodiment, in response to a search (such as a search run in the search area), the GUI 500 may display attributes 514 matching the search criteria in a first area. In an embodiment, the attributes may be displayed with information related to the attributes in an organized manner. For example, in an embodiment, the first area may display the attributes in a table format. Each row of the table may represent an attribute, and each column of each row may present information related to that attribute.

In an embodiment, a second area may present information 512 related to a selected attribute from the first area. In an embodiment, a displayed attribute may be selected by clicking on the row representing the attribute in the first display area. In response to selecting an attribute in the first area, the row representing the attribute may be highlighted, outlined by a shadow, etc., to indicate that the attribute has been selected. In an embodiment, in response to selecting an attribute in the first area, information 512 related to that attribute may be automatically populated in the second area.

In an embodiment, the information related to attribute(s) displayed in the first area and/or the second area may include an identifier identifying the attribute, the namespace of the attribute, the release status of the attribute, the data type of the attribute, whether there is write access to the attribute, the BO which the attribute belongs to, the node which the attribute belongs to, the attribute UI text, data type namespace, data type representation term, data type release status, alternative key, foreign key usage, if the attribute is mandatory, if the attribute is enabled in the software, and if the attribute is read-only. In an embodiment, the write access information may be displayed for different types of users. For example, in an embodiment, the write access level for a partner may be displayed. In another embodiment, the write access level for a consumer of the software may be displayed.

In an embodiment, a grouping field 516 may be displayed on GUI 500. The displayed results 514 may be grouped based on criteria specified in the grouping field 516. For example, as illustrated, in an embodiment, the results 514 may be grouped based on nodes. Specifically, the attributes belonging to a first node (such as the root node) may be displayed first, the attributes belonging to a second node may be displayed second, and so on.

In an embodiment, the GUI 500 may display mechanisms to view attribute information unable to fit on the GUI 500 as discussed with reference to GUI 200 (FIG. 2) above. In an embodiment, a filtering field (not shown) may be displayed on GUI 500, and may operate as discussed with reference to GUI 300 above.

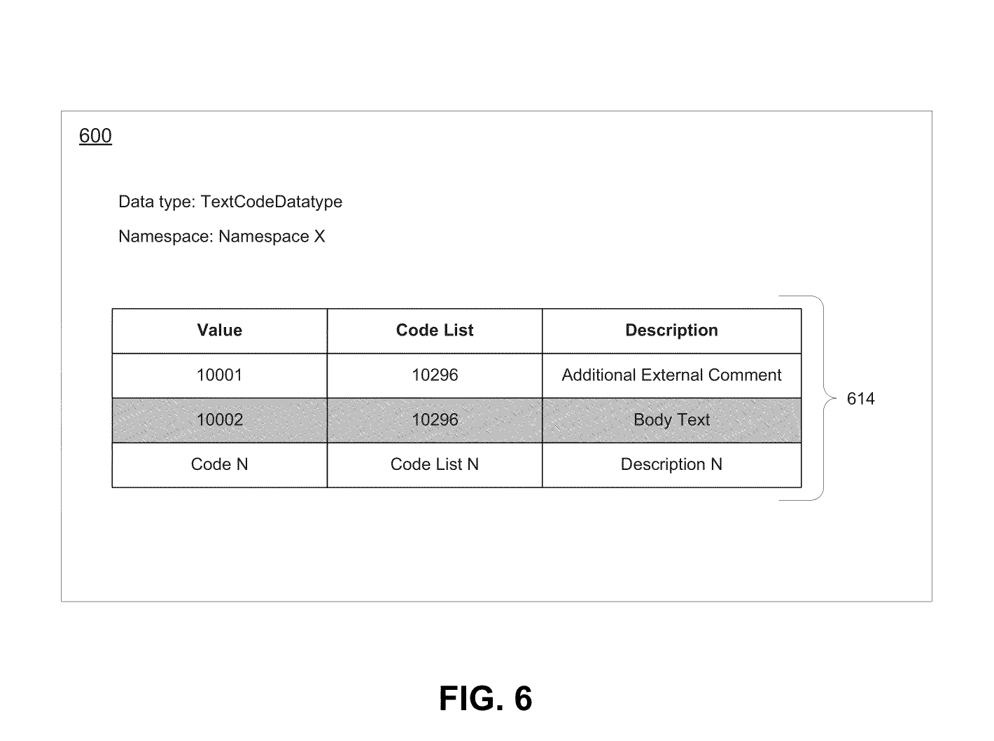

FIG. 6 illustrates a GUI 600 to search and display details of data types according to an embodiment. In an embodiment, the GUI 600 may include a search area (not shown) similar to the search area described in GUI 100 (FIG. 1) to search for data types. In an embodiment, in response to a search (such as a search run in the search area), the GUI 600 may display data type information 614 matching the search criteria in the search area. In an embodiment, the information may be displayed in an organized manner. For example, in an embodiment, the information may be displayed in a table format. Each row of the table may represent a possible value of a data type, and each column of each row may present information related to that value.

In an embodiment, the displayed information may include a description of the data type value. The value of a data type may be used when a software program is executing to keep track of a state of a variable (such as an attribute). However, the value may not be descriptive. The description of the data type value may relay more information about the data type value to a user. For example, a data type may include many numeric values. Each numeric value may have a particular meaning, and this meaning may be displayed as the value's description in GUI 600.

In an embodiment, the GUI 600 may display mechanisms to view attribute information unable to fit on the GUI 600 as discussed with reference to GUI 200 (FIG. 2) above. In an embodiment, a filtering field (not shown) may be displayed on GUI 600, and may operate as discussed with reference to GUI 300 above.

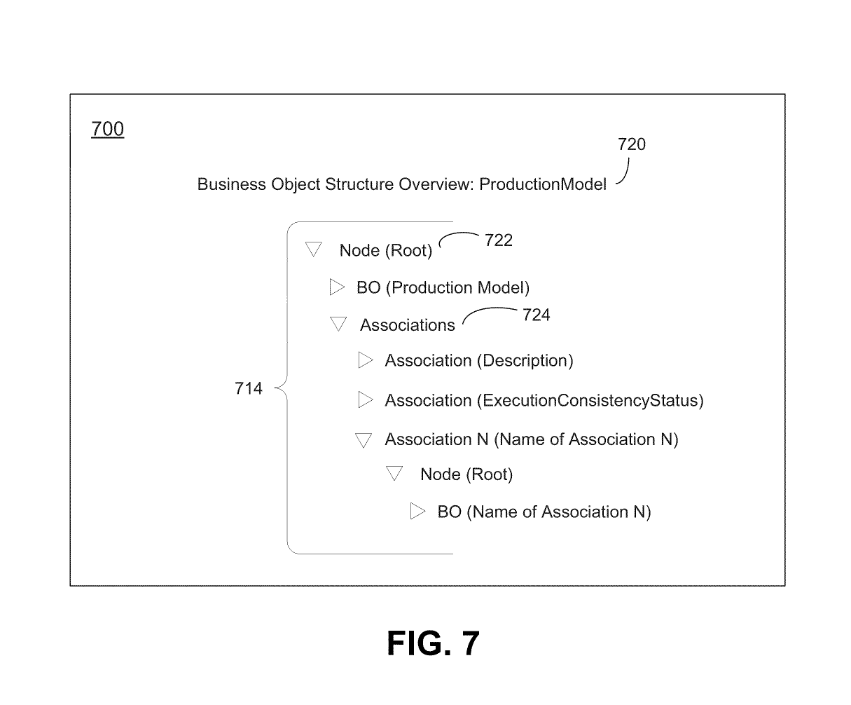

FIG. 7 illustrates a GUI 700 to search and display details of BOs, BO instances, and/or nodes as a tree representation according to an embodiment. In an embodiment, the GUI 600 may include a search area (not shown) similar to the search area described in GUI 100 (FIG. 1) to search for BOs, BO instances, and/or nodes. In an embodiment, in response to a search (such as a search run in the search area), the GUI 700 may display BO/BOinstance/node information 714 matching the search criteria in the search area. In an embodiment, the information may be displayed in an organized manner. For example, in an embodiment, the information may be displayed in a tree format.

In an embodiment, each branch of the tree may represent a node(s), BO(s), BO instance(s), action(s), association(s), one or more queries, key(s), and/or child node(s). Each branch of the tree may indicate the type of data represented by that branch and an identifier identifying that data. For example, in an embodiment, a search performed in the search area may return information 714 about the BO, production model 720. The initial branch displayed may be the root node 722. The initial branch may include two sets of information: the type of data in that branch (“node”) and the identifier identifying that data (“root”).

In an embodiment, the user may expand a branch to view more information under that branch. For example, the user may expand the branch 722 (by an action such as clicking on the branch) to view all information under the branch 722. In an embodiment, under the root node branch 722 associations 724 associated to that root node may be displayed. The user may then expand the associations to view each individual association.

In an embodiment, the GUI 700 may display mechanisms to view attribute information unable to fit on the GUI 700 as discussed with reference to GUI 200 (FIG. 2) above. In an embodiment, a filtering field (not shown) may be displayed on GUI 700, and may operate as discussed with reference to GUI 300 above.

A person having ordinary skill in the art will appreciate that the GUIs illustrated in FIGS. 1-7 may be displayed separately or may be displayed together as part of one or more other GUIs. In an embodiment, entering information in one GUI may trigger the display of another GUI. For example, identifying a BO in GUI 200 may trigger the display of GUI 300. The GUIs illustrated in FIGS. 1-7 may include buttons to confirm that a particular action was taken by the user. For example, GUI 100 may include button called “search” in a search area so that the user can confirm that the user intends to run a search corresponding to the search parameters. A person having ordinary skill in the art will also appreciate that the GUIs illustrated in FIGS. 1-7 don't have to be displayed in any particular order.

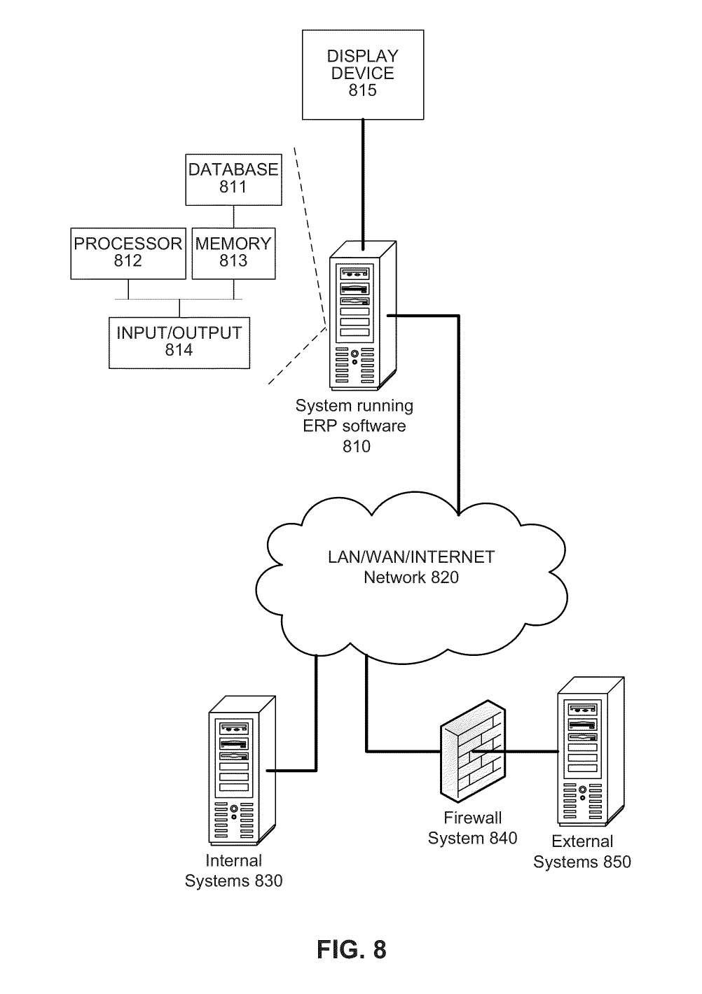

FIG. 8 shows an exemplary architecture in an embodiment of the invention. The system running an application to view, create, and/or modify BOs, BO instances, data types, and/or nodes 810 may be coupled to a display device 815, existing internal systems 830 through a network 820 and to external systems 850 through the network 820 and firewall system 840. The system running an application to view, create, and/or modify BOs, BO instances, and/or nodes 810 may include a desktop computer, laptop computer, tablet PC, client computer, mobile phone, central computer in a vehicle, and any other computer. The display device 815 may include a computer monitor, a tablet PC screen, a mobile phone screen, and any other displays. The existing internal systems 830 may include a server and may provide business data and/or other data. The external systems 850 may include a server and may be maintained by a third party, such as an information service provider, and may contain business data and/or other data, that may be updated by the third party on a periodic basis. The system running an application to view, create, and/or modify BOs, BO instances, data types, and/or nodes 810 may interact with these external systems to obtain updates through a firewall system 840 separating the internal systems from the external systems.

A person having ordinary skill in the art will appreciate that while internal systems 830 and external systems 850 are included in FIG. 8, in some embodiments, one or both of these systems may not be required. In an embodiment, the functionality provided by the internal systems 830 and external systems 850 may be provided by the system running the application to view, create, and/or modify BOs, BO instances, data types, and/or nodes 810.

Each of the systems in FIG. 8 may contain a processing device 812, memory 813, a database 811, and an input/output interface 814, all of which may be interconnected via a system bus. In various embodiments, each of the systems 810, 830, 840, and 850 may have an architecture with modular hardware and/or software systems that include additional and/or different systems communicating through one or more networks. The modular design may enable a business to add, exchange, and upgrade systems, including using systems from different vendors in some embodiments. Because of the highly customized nature of these systems, different embodiments may have different types, quantities, and configurations of systems depending on the environment and organizational demands.

In an embodiment, memory 813 may contain different components for retrieving, presenting, changing, and saving data. Memory 813 may include a variety of memory devices, for example, Dynamic Random Access Memory (DRAM), Static RAM (SRAM), flash memory, cache memory, and other memory devices. Additionally, for example, memory 813 and processing device(s) 812 may be distributed across several different computers that collectively comprise a system.

Database 811 may include any type of data storage adapted to searching and retrieval. The database 811 may include SAP database (SAP DB), Informix, Oracle, DB2, Sybase, and other such database systems. The database 811 may include SAP's HANA (high performance analytic appliance) in-memory computing engine and other such in-memory databases.

Processing device 812 may perform computation and control functions of a system and comprises a suitable central processing unit (CPU). Processing device 812 may comprise a single integrated circuit, such as a microprocessing device, or may comprise any suitable number of integrated circuit devices and/or circuit boards working in cooperation to accomplish the functions of a processing device. Processing device 812 may execute computer programs, such as object-oriented computer programs, within memory 813.

The foregoing description has been presented for purposes of illustration and description. It is not exhaustive and does not limit embodiments of the invention to the precise forms disclosed. Modifications and variations are possible in light of the above teachings or may be acquired from the practicing embodiments consistent with the invention. For example, some of the described embodiments may include software and hardware, but some systems and methods consistent with the present invention may be implemented in software or hardware alone. Additionally, although aspects of the present invention are described as being stored in memory, this may include other computer readable media, such as secondary storage devices, for example, solid state drives, or DVD ROM; the Internet or other propagation medium; or other forms of RAM or ROM.

1. A method for processing electronic documents with business systems, comprising:
receiving at least one electronic document in a control system connected to at least one business system;
extracting contents from the at least one electronic document by the control system according to an extraction table in the control system, wherein the extraction table defines the contents to be extracted for each type of electronic document that is processed;
determining, by the control system, a business process to be implemented, from a plurality of business processes defined in a business processes table in the control system, based on a comparison of at least one of the extracted contents to an extracted content table in the control system, wherein the extracted content table defines an associated business process for each of the at least one extracted contents;
determining, by the control system, a sequence of processing steps to be implemented, from a plurality of processing steps defined in a process steps table in the control system, based on a comparison of the determined business process to a process flow sequence table in the control system, wherein the process flow sequence table defines the sequence of processing steps for each business process; and
implementing the sequence of processing steps by the control system according to a control process flow table in the control system, wherein the control process flow table defines pre-requisites for implementing a next processing step in the sequence of processing steps for each business process.

2. The method of claim 1, wherein the at least one electronic document is an XML document.

3. The method of claim 1, wherein the at least one extracted contents used for the comparison to an extracted content table includes tax code information.

4. The method of claim 1, wherein the sequence of processing steps for a business process can be altered based on a comparison of at least one of the extracted contents to a control parameters table in the control system.

5. The method of claim 4, wherein the at least one extracted contents used for the comparison to the control parameters table includes at least one of a) business partner information, and b) tax code information.

6. The method of claim 4, wherein the alteration of the sequence of processing steps for a business process includes at least one of a) a processing step being defined as automatic or manual, and b) a processing step being deactivated or reactivated.

7. The method of claim 1, wherein the process steps table defines attributes for each process step including at least one of a) whether the processing step is optional or mandatory within each business process, b) whether the processing step can be carried out automatically or also manually, and c) whether the processing step can be deactivated.

8. The method of claim 1, the prerequisites for each processing step includes checking whether previous processing steps in the sequence of processing steps have been implemented.

9. The method of claim 1, wherein the prerequisites for each processing step includes checking at least one of a) whether the processing step can be executed automatically, and b) whether the processing step is deactivated.

10. The method of claim 1, wherein the implementation of a processing step in the sequence of processing steps for each business process is implemented in either the at least one business system or the control system based on the definition of the processing step in the process steps table.

11. The method of claim 10, wherein if the control system is connected to a plurality of business systems and the implementation of a processing step in the sequence of processing steps for a business process is defined as being implemented in at least one business system then the business system in which the processing step is implemented is determined based on at least one of the extracted contents.

12. The method of claim 1, wherein the implementation of the sequence of processing steps for each business process is stopped and automatically continued at a later time if there is an error or if a step cannot be implemented automatically.

13. A non-transitory computer-readable medium having stored thereon instructions adapted to be executed by a processor, the instructions which, when executed, cause the processor to perform a method for processing electronic documents with business systems, comprising:
receiving at least one electronic document in a control system connected to at least one business system;
extracting contents from the at least one electronic document according to an extraction table in the control system, wherein the extraction table defines the contents to be extracted for each type of electronic document that is processed;
determining a business process to be implemented, from a plurality of business processes defined in a business processes table in the control system, based on a comparison of at least one of the extracted contents to an extracted content table in the control system, wherein the extracted content table defines an associated business process for each of the at least one extracted contents;
determining a sequence of processing steps to be implemented, from a plurality of processing steps defined in a process steps table in the control system, based on a comparison of the determined business process to a process flow sequence table in the control system, wherein the process flow sequence table defines the sequence of processing steps for each business process; and
implementing the sequence of processing steps according to a control process flow table in the control system, wherein the control process flow table defines pre-requisites for implementing a next processing step in the sequence of processing steps for each business process.

14. A system for processing electronic documents with business systems, comprising:
at least one business system including a processor; and
a control system including a processor and connected to the at least one business system, the control system configured to:
receive at least one electronic document;
extract contents from the at least one electronic document according to an extraction table in the control system, wherein the extraction table defines the contents to be extracted for each type of electronic document that is processed;
determine a business process to be implemented, from a plurality of business processes defined in a business processes table in the control system, based on a comparison of at least one of the extracted contents to an extracted content table in the control system, wherein the extracted content table defines an associated business process for each of the at least one extracted contents;
determine a sequence of processing steps to be implemented, from a plurality of processing steps defined in a process steps table in the control system, based on a comparison of the determined business process to a process flow sequence table in the control system, wherein the process flow sequence table defines the sequence of processing steps for each business process; and
implement the sequence of processing steps according to a control process flow table in the control system, wherein the control process flow table defines pre-requisites for implementing a next processing step in the sequence of processing steps for each business process.

15. The system of claim 14, wherein the at least one extracted contents used for the comparison to an extracted content table includes tax code information

16. The system of claim 14, wherein the sequence of processing steps for a business process can be altered based on a comparison of at least one of the extracted contents to a control parameters table in the control system.

17. The system of claim 16, wherein the at least one extracted contents used for the comparison to the control parameters table includes at least one of a) business partner information, and b) tax code information.

18. The system of claim 16, wherein the alteration of the sequence of processing steps for a business process includes at least one of a) a processing step being defined as automatic or manual, and b) a processing step being deactivated or reactivated.

19. The system of claim 14, wherein the prerequisites for each processing step includes checking whether previous processing steps in the sequence of processing steps have been implemented.

20. The system of claim 14, wherein the implementation of a processing step in the sequence of processing steps for each business process is implemented in either the at least one business system or the control system based on the definition of the processing step in the process steps table.
